(19) United States
(12) Patent Application Publication
(10) Pub. No.: US 2025/0110279 A1
(43) Pub. Date: Apr. 3, 2025

(54) TUNABLE-GAP INTEGRATED PHOTONIC CIRCUITS

(71) Applicant: The MITRE Corporation, McLean, VA (US)

(72) Inventors: Gerry GILBERT, Princeton, NJ (US); Henry WEN, Reading, MA (US)

(73) Assignee: The MITRE Corporation, McLean, VA (US)

(21) Appl. No.: 18/899,545

(22) Filed: Sep. 27, 2024

Related U.S. Application Data
(60) Provisional application No. 63/541,589, filed on Sep. 29, 2023.

(51) Int. Cl. G02B 6/28; G02F 1/025

(52) U.S. Cl. CPC G02B 6/283; G02F 1/025; G02F 2203/50

(57) ABSTRACT

A photonic device may include a pair of piezoelectric actuators, a waveguide suspended between and mechanically coupled to the pair of piezoelectric actuators, and a voltage source configured to apply an actuation voltage to the pair of piezoelectric actuators to induce longitudinal motion in each actuator of the pair of piezoelectric actuators. The longitudinal motion of the pair of piezoelectric actuators may induce lateral motion in the waveguide. In addition, the photonic device may include optoelectronic element that is spatially separated from the waveguide by a coupling gap. The lateral motion induced in the waveguide may reduce the size of the coupling gap for evanescently coupling the waveguide to the optoelectronic element during operation.

### CROSS-REFERENCE TO RELATED APPLICATIONS

This application claims the benefit of U.S. Provisional Application No. 63/541,589, filed Sep. 29, 2023, the entire contents of which is incorporated herein by reference.

### FIELD

The present disclosure relates generally to photonic coupling devices, in particular to tunable photonic coupling devices such as tunable directional couplers.

### BACKGROUND

Photonic processing and control systems are critical components of many optoelectronic architectures, including quantum computing systems and optical neural networks. Among the basic building blocks of these systems are photonic couplers (e.g., directional couplers) that transmit optical signals between evanescently coupled optoelectronic components.

The tunability of the photonic couplers in a photonic processor can have significant impacts on programmability and switching in the processor as well as the ability of the processor to compensate for fabrication defects. Achieving sufficient tunability in such couplers can be challenging, since tuning a coupler requires either modulation of the material index in the evanescent coupling region or modulation of the separation distance between the optoelectronic components being coupled. Existing tunable photonic couplers frequently have slow response rates and large footprints, rely on auxiliary devices (e.g., Mach-Zehnder interferometers), and are intolerant to fabrication imperfections, and, as a result, are unsuitable for use in many photonic processing systems.

### SUMMARY

Described herein are examples of photonic devices that utilize piezoelectric actuation to induce and amplify motion in waveguides. The devices may convert motion of a pair of piezoelectric actuators into motion in a waveguide that is suspended between actuators. When integrated into a larger photonic circuit, such a photonic device may facilitate on-demand modulation of the separation distance—and, as a result, the evanescent coupling—between the waveguide and other optoelectronic components (e.g., another waveguide, a ring cavity, a phase shifter, etc.).

Leveraging piezoelectric actuation may provide the described devices with robust tolerance to fabrication defects and may enable the devices to be manufactured using platforms such as a CMOS 200 mm platform. Since a relatively small amount of motion in the piezoelectric actuators can induce a large amount of motion in the waveguide, the provided devices may be capable of modulating gaps between optoelectronic components at high speeds. As such, the described devices may be implemented in photonic processing and control systems with strict control requirements, such as those used for quantum computing applications.

A photonic device may include a pair of piezoelectric actuators, a waveguide suspended between and mechanically coupled to the pair of piezoelectric actuators, and a voltage source configured to apply an actuation voltage to the pair of piezoelectric actuators to induce longitudinal motion in each actuator of the pair of piezoelectric actuators, wherein the longitudinal motion of the pair of piezoelectric actuators induces lateral motion in the waveguide. In addition, the photonic device may include optoelectronic element that is spatially separated from the waveguide by a coupling gap. The lateral motion induced in the waveguide may reduce the size of the coupling gap for evanescently coupling the waveguide to the optoelectronic element during operation.

The optoelectronic element can be a second waveguide. The second waveguide may be suspended between and mechanically coupled to the pair of piezoelectric actuators, and the longitudinal motion induced in the pair of piezoelectric actuators by the application of the actuation voltage induces lateral motion in the second waveguide that reduces the size of the coupling gap. Alternatively, the second optoelectronic element may be a phase-shifting device that is configured to change a phase of an evanescently-coupled optical signal. The optoelectronic element can also be a ring cavity.

The waveguide may be a silicon nitride (SiN) waveguide. Each actuator of the pair of piezoelectric actuators may include a layer of piezoelectric material disposed between a pair of electrodes. The piezoelectric material may comprise aluminum nitride (AlN). The voltage source may be electrically coupled to the pair of electrodes of each actuator of the pair of piezoelectric actuators. Each actuator of the pair of piezoelectric actuators may comprise a cladding that mechanically couples the waveguide to the actuator. The cladding may be a silicon dioxide cladding.

The lateral motion induced in the waveguide may be amplified relative to the longitudinal motion of the pair of piezoelectric actuators. In some embodiments, the total amount of lateral motion induced in the waveguide is at least twenty times a total amount of longitudinal motion induced in the pair of piezoelectric actuators.

Methods for controlling motion of a waveguide in a photonic device are also provided. Such a method can include determining an actuation voltage and applying the actuation voltage to a pair of piezoelectric actuators using a voltage source to induce longitudinal motion in each actuator of the pair of piezoelectric actuators. The longitudinal motion of the pair of piezoelectric actuators may induce lateral motion in a waveguide that is suspended between and mechanically coupled to the pair of piezoelectric actuators. The lateral motion induced in the waveguide may the size of a coupling gap between the waveguide and an optoelectronic element and evanescently couples the waveguide to the optoelectronic element. The method can further include transmitting an optical signal to the waveguide and, while applying the actuation voltage, transferring the optical signal between the waveguide and the optoelectronic element.

The optoelectronic element may be a second waveguide. The second waveguide may be suspended between and mechanically coupled to the pair of piezoelectric actuators, and the longitudinal motion induced in the pair of piezoelectric actuators by the application of the actuation voltage may induce lateral motion in the second waveguide that reduces the size of the coupling gap. The method may involve determining a splitting ratio of the waveguides; the actuation voltage may be determined based on the splitting ratio.

The optoelectronic element can also be a phase-shifting device. The method may comprise determining a phase shift. The actuation voltage may be determined based on the phase shift. Alternatively, the optoelectronic element may be a ring cavity, and the method may involve storing an optical signal in the ring cavity and, while applying the actuation voltage, transferring the optical signal from the ring cavity to the waveguide.

### BRIEF DESCRIPTION OF THE FIGURES

The invention will now be described, by way of example only, with reference to the accompanying drawings.

FIG. 1 shows a piezoelectrically-actuated tunable photonic device, according to some embodiments.

FIG. 2 shows a side view of a piezoelectric actuator, according to some embodiments.

FIG. 3A shows a cross-sectional view of a waveguide, according to some embodiments.

FIG. 3B shows a cross-sectional view of a piezoelectric actuator, according to some embodiments.

FIG. 4A shows a piezoelectrically-actuated tunable directional coupler prior to actuation, according to some embodiments.

FIG. 4B shows a piezoelectrically-actuated tunable directional coupler during actuation, according to some embodiments.

FIG. 5 shows a method of using a piezoelectrically-actuated tunable directional coupler, according to some embodiments.

FIG. 6A shows a bar state of tunable directional coupler, according to some embodiments.

FIG. 6B shows a cross state of tunable directional coupler, according to some embodiments.

FIG. 6C provides example data showing a relationship between actuation voltage and cross and bar port transmission in a piezoelectrically-actuated tunable directional coupler.

FIG. 6D provides example data showing a relationship between optical contrast and actuator driving frequency in a piezoelectrically-actuated tunable directional coupler.

FIG. 6E provides example data showing time traces of resonant modulation of a piezoelectrically-actuated tunable directional coupler.

FIG. 7 shows a method for controlling the phase of an optical signal using a piezoelectrically-actuated tunable photonic device, according to some embodiments.

FIG. 8 shows a piezoelectrically-actuated tunable photonic device for controlling the phase of an optical signal, according to some embodiments.

FIG. 9 shows a method for transferring an optical signal between a ring cavity and a waveguide using a piezoelectrically-actuated tunable photonic device, according to some embodiments.

FIG. 10A shows a piezoelectrically-actuated tunable photonic device for transferring an optical signal to a ring cavity, according to some embodiments.

FIG. 10B shows a piezoelectrically-actuated tunable photonic device for retrieving an optical signal from a ring cavity, according to some embodiments.

FIG. 11A shows a piezoelectrically-actuated tunable photonic device implementing a full SU2 transformation, according to some embodiments.

FIG. 11B shows a close-up view of motion induced in a pair of waveguides that are components of piezoelectrically-actuated tunable photonic device implementing a full SU2 transformation, according to some embodiments.

FIG. 12 shows a computer system, according to some embodiments.

### DETAILED DESCRIPTION

The tunability of the photonic couplers in a photonic processor can have significant impacts on programmability and switching in the processor as well as the ability of the processor to compensate for fabrication defects. The examples of photonic devices described herein leverage piezoelectric actuation to induce motion in waveguides in order to modulate the evanescent coupling between the waveguides and other optoelectronic components. In the described devices, even modest driving signals may be capable of producing strong responses in a waveguide, which may enhance the devices' scalability and versatility. In particular, the provided devices may be implemented in photonic processing and control systems with strict control requirements, such as those used for quantum computing applications, and may be easily adapted for various applications within a photonic circuit, including directional coupling, phase modulation, and photon storage.

Any of the systems, methods, techniques, and/or features disclosed herein may be combined, in whole or in part, with any other disclosed systems, methods, techniques, and/or features. As used herein, the singular forms “a”, “an”, and “the” include the plural reference unless the context clearly dictates otherwise. Reference to “about” a value or parameter or “approximately” a value or parameter herein includes (and describes) variations that are directed to that value or parameter per se. For example, description referring to “about X” includes description of “X”. It is understood that aspects and variations of the invention described herein include “consisting of” and/or “consisting essentially of” aspects and variations.

When a range of values or values is provided, it is to be understood that each intervening value between the upper and lower limit of that range, and any other stated or intervening value in that stated range, is encompassed within the scope of the present disclosure. Where the stated range includes upper or lower limits, ranges excluding either of those included limits are also included in the present disclosure.

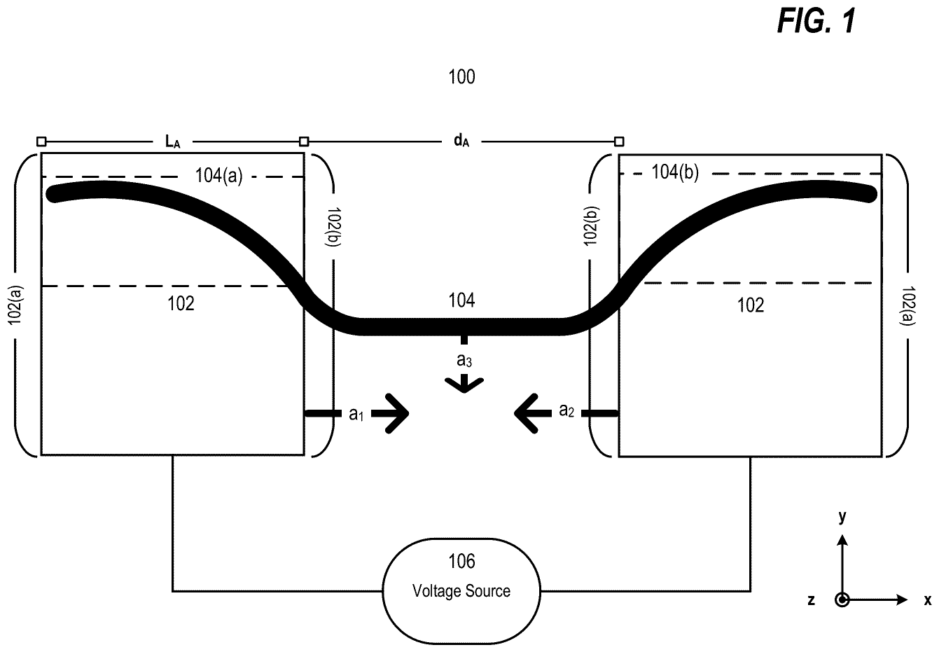

An exemplary piezoelectrically-actuated tunable photonic device 100 is depicted in FIG. 1. Device 100 may include a pair of piezoelectric actuators 102 and a waveguide 104. Waveguide 104 may be mechanically coupled to each actuator 102 such that a portion of waveguide 104 is suspended between actuators 102. A voltage source 106 may be electrically coupled to each actuator 102.

Actuators 102 may be cantilevers—that is, each actuator 102 may be supported at one end and unsupported at the opposite end. Each actuator 102 may extend from a fixed a distal edge 102(a) (which may be anchored, e.g., to a photonic integrated circuit chip) to an unsupported proximal edge 102(b).

A first portion 104(a) of waveguide 104 may overlap with and be mechanically coupled (e.g., affixed) to one actuator of the pair of actuators 102. The mechanical coupling between first portion 104(a) and the actuator with which it overlaps may be facilitated by a cladding that is disposed on top of the actuator and first portion 104(a). Similarly, a second portion 104(b) of waveguide 104 may overlap with and be mechanically coupled to the other actuator of the pair of actuators 102. The mechanical coupling between second portion 104(b) and the actuator with which it overlaps may be facilitated by a cladding that is disposed on top of the actuator and second portion 104(b). The portion of waveguide 104 between first portion 104(a) and second portion 104(b) may be suspended between the proximal edges 102(b) of the pair of actuators 102 such that it has freedom to move or deform in at least one direction.

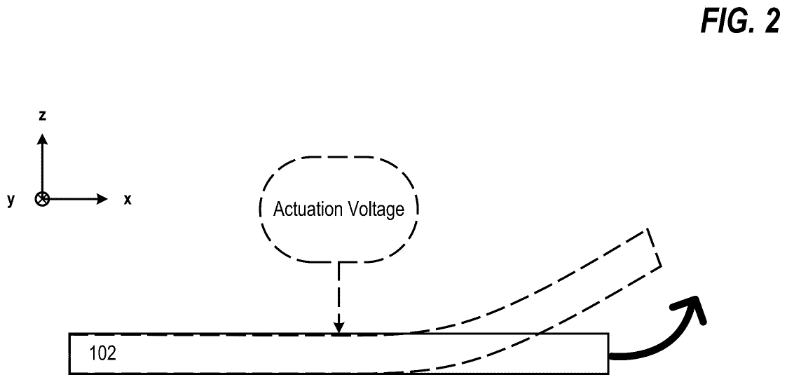

In an unactuated state (e.g., when no voltage is applied to actuators 102 by voltage source 106), actuators 102 and waveguide 104 may lie in the same plane. In FIG. 1, this plane is defined to be the x-y plane. When a voltage is applied to actuators 102 by voltage source 106, mechanical strain may be induced in piezoelectric actuators 102. This mechanical strain may cause each actuator 102 to expand within the unactuated (x-y) plane and to deflect out of (e.g., in a direction perpendicular to) the unactuated (x-y) plane. Specifically, each actuator 102 may expand within the unactuated (x-y) plane toward the other actuator (as indicated by arrows a₁ and a₂) and may deflect out of the unactuated (x-y) plane in the +z direction or in the −z direction. The net motion of each actuator 102 toward the other actuator, referred to hereinafter as the actuator's net “longitudinal” motion, may be a combination of the magnitude of the actuator's expansion within the unactuated (x-y) plane toward the other actuator and the magnitude of the component of the actuator's out-of-plane deflection that is parallel to the unactuated (x-y) plane. In FIG. 1, the actuators' longitudinal motion is along the x direction. Side views of an actuator 102 (without the waveguide 104) in an exemplary unactuated state (solid line) and in an exemplary actuated state (dashed line) are provided in FIG. 2.

The longitudinal motion of each actuator 102 in an actuated state may generate mechanical stress in waveguide 104 that causes the portion of waveguide 104 that is suspended between actuators 104 to move (e.g., bend, flex, etc.) “laterally” in a direction that is substantially orthogonal to the longitudinal motion of actuators 102 (the y direction in FIG. 1), e.g., as indicated by arrow a₃ in FIG. 1. Controlling the lateral motion of waveguide 104 (e.g., by changing the voltage applied to actuators 102 to adjust the amount of longitudinal motion induced in actuators 102) may thus allow a separation distance between waveguide 104 and another optoelectronic component (e.g., another waveguide) to be altered, which may, in turn, enable the evanescent coupling between waveguide 104 and the other optoelectronic component to be tuned.

When moving laterally, waveguide 104 may move primarily within the unactuated (x-y) plane. Waveguide 104 may deflect out of the unactuated (x-y) plane in the +z directions; however, the amount of deflection out of the unactuated (x-y) plane may be small relative to the amount of motion within the unactuated (x-y) plane. Waveguide 104 may move laterally by at least 0.25 μm, at least 0.5 μm, at least 0.75 μm, at least 1 μm, at least 5 μm, or at least 10 μm. In some embodiments, when waveguide 104 moves laterally, the shape of waveguide 104 stays substantially the same. For example, the portion of waveguide 104 that is suspended between proximal ends 102(b) of actuators 102 may remain substantially linear as waveguide 104 moves laterally. In other embodiments, when waveguide 104 moves laterally, the shape of waveguide 104 may change. For instance, when waveguide 104 moves laterally, the portion of waveguide 104 that is suspended between proximal ends 102(b) of actuators 102 may deform (e.g., bulge or curve) in the direction of the lateral motion (e.g., in the direction indicated by arrow a₃ in FIG. 1).

Voltage source 106 may be any device capable of applying an electrical signal to actuators 102. Voltage source 106 may be configured to apply a direct current (DC) signal or an alternating current (AC) signal to actuators 102. The voltage applied to actuators 102 (the “actuation voltage”) may affect the amount and the direction of the motion induced in actuators 102. The properties (e.g., magnitude, frequency, etc.) of actuation voltage signals applied to actuators 102 may be controlled automatically (e.g., by a processor configured to control voltage source 106) or manually (e.g., by a user directly controlling voltage source 106). In various embodiments, voltage source 106 may enable DC actuation voltages ranging between 0-25 V, 0-50 V, 0-75 V, 0-100 V, −25-25 V, −25-50 V, −25-75 V, −25-100 V, −50-25 V, −50-50 V, −50-75 V, −50-100 V, −75-25 V, −75-50 V, −75-75 V, −75-100 V, −100-25 V, −100-50 V, −100-75V, or −100-100 V to be applied to actuators 102. In some cases, a DC actuation voltage may be less than or equal to −100 V or greater than or equal to 100 V. AC signals applied to actuators 102 may have peak-to-peak voltages (Vₚₚ) of at least 0.1, 0.25 V, 0.5 V, 0.75, 1 V, or 1.5 V or less than 2 V, 1 V, 0.75 V, or 0.5 V, and may have frequencies ranging between 0-100 MHz, 0-200 MHz, 0-300 MHz, 0-400 MHz, or 0-500 MHz. In some embodiments, voltage source 106 may enable AC signals with frequencies greater than 500 MHZ (e.g., frequencies greater than 1000 MHZ) to be applied to actuators 102.

In some embodiments, voltage source 106 is configured to actuate each actuator 102 independently. That is, voltage source 106 may be configured to apply a first actuation voltage to one actuator and a second actuation voltage to the other actuator. This may enable asymmetries in actuators 102 (due to, e.g., fabrication imperfections or variations) to be compensated for when device 100 is in use. Additionally, independently actuating each actuator 102 may allow device 100 to achieve more nuanced control of the motion of waveguide 104.

When a negative actuation voltage is applied to an actuator 102, said actuator may deflect out of the unactuated (x-y) plane in a direction opposite to the direction in which the actuator deflects under the application of a positive actuation voltage. For example, a negative actuation voltage may cause an actuator 102 to deflect in the −z direction, while a positive actuation voltage may cause actuator 102 to deflect in the +z direction. In some embodiments, the pair of actuators 102 may be configured such that, at the same actuation voltage, one actuator deflects in a first direction and the other actuator deflects in a second direction that is opposite to the first direction.

The magnitude of lateral displacement induced in waveguide 104 at a given actuation voltage may be greater than the magnitude of longitudinal displacement in actuators 102 at said voltage. That is, the lateral motion of waveguide 102 may be amplified relative to the longitudinal motion of actuators 102 that caused the lateral motion. For example, longitudinal motion of actuators 102 on the order of 1, 10, or 100 nanometers may be respectively amplified into tens, hundreds, or thousands nanometers of lateral motion of waveguide 104. The lateral motion of waveguide 104 can, in other words, be greater than the longitudinal motion of actuators 102 by a factor of, at least 5, at least 10, at least 15, at least 20, at least 25, at least 30, at least 35, at least 40, at least 45, or at least 50.

The amplification of the motion of actuators 102 may reduce the size requirements of device 100. In some embodiments, the total footprint of device 100 is less than or equal to 1, 0.5, 0.1, 0.01, 0.001, or 0.0001 mm².

The lateral motion induced in waveguide 104 at a given actuation voltage may depend on the force applied to waveguide 104, the amount by which the longitudinal motion of actuators 102 is amplified when converted to lateral motion in waveguide 104, and the stiffness of waveguide 104. The force applied to waveguide 104 by an actuator 102 may be directly (though not necessarily linearly) related to the actuator width, the actuator length, or a combination thereof, i.e., may increase (linearly or otherwise) as the actuator width, the actuator length, or a combination thereof increases. The amount by which the longitudinal motion of actuators 102 is amplified when converted to lateral motion in waveguide 104 may depend directly (though not necessarily linearly) on the length of waveguide 104, the convergence angle of waveguide 104, or a combination thereof, i.e., may increase (linearly or otherwise) as the waveguide length, the waveguide convergence angle, or a combination thereof increases. The stiffness of waveguide 104 may depend on the thickness of waveguide 104, the width of waveguide 104, or a combination thereof, i.e., may increase (linearly or otherwise as the waveguide thickness, the waveguide width, or a combination thereof increases.

In some embodiments, the separation distance da between the pair of actuators 102 is approximately equal to (e.g., within 1%, 5%, 10%, 15%, or 20% of) 50, 75, 100, 125, 150, 175, 200, or 225 μm. In some embodiments, the separation distance da between the pair of actuators 102 is greater than or equal to 25, 50, 75, or 100 μm. In some embodiments, the separation distance da between the pair of actuators 102 is less than or equal to 300, 275, 250, 225, or 200 μm. In some embodiments, the separation da between the pair of actuators 102 is approximately equal to (e.g., within 1%, 5%, 10%, 15%, or 20% of) the length L_{A} between the distal and proximal edges 102(a)-102(b) of each actuator 102;

In some embodiments, the length L_{A} between the distal and proximal edges 102(a)-102(b) of each actuator 102 is approximately equal to (e.g., within 1%, 5%, 10%, 15%, or 20% of) 50, 75, 100, 125, 150, 175, 200, or 225 μm. In some embodiments, the length L_{A} between the distal and proximal edges 102(a)-102(b) of each actuator 102 is greater than or equal to 25, 50, 75, or 100 μm. In some embodiments, the length L_{A} between the distal and proximal edges 102(a)-102(b) of each actuator 102 is less than or equal to 300, 275, 250, 225, or 200 μm. In some embodiments, the length L_{A} between the distal and proximal edges 102(a)-102(b) of each actuator 102 is approximately equal to (e.g., within 1%, 5%, 10%, 15%, or 20% of) the separation distance d between the pair of actuators 102;

Device 100 may be a component of a photonic integrated circuit (PIC) in a photonic processing or control system such as a quantum computer, an optical neural network, or an atomic control system. Waveguide 104 may be coupled to other optoelectronic components in the PIC or may extend past the distal ends 102(a) of one or more of the pair of actuators 102 into another portion of the PIC. Voltage source 106 may be a battery, a capacitor, or other (AC or DC) power supply for the PIC and may be electrically coupled to actuators 102 by, e.g., wires or electrically conductive traces in a circuit board. Device 100 may be manufactured using a semiconductor manufacturing platform such as a CMOS 200 mm platform.

Waveguide 104 may be comprised of any suitable material, including (but not limited to) silicon nitride (SiN) and diamond. The material composition of waveguide 104 can depend on the system in which device 100 is integrated. If device 100 is a component of a quantum computing system, for example, waveguide 104 may be configured to host physical qubits. For instance, waveguide 104 may be embedded with solid-state defects (e.g., nitrogen vacancy centers) that are configured to encode physical qubits. In such an implementation, actuators 102 may, in addition to inducing motion in waveguide 104, be used to control the quantum states of the qubits that are hosted by waveguide 104, as described in U.S. patent application Ser. No. 18/140,813, the entire contents of which is incorporated herein by reference.

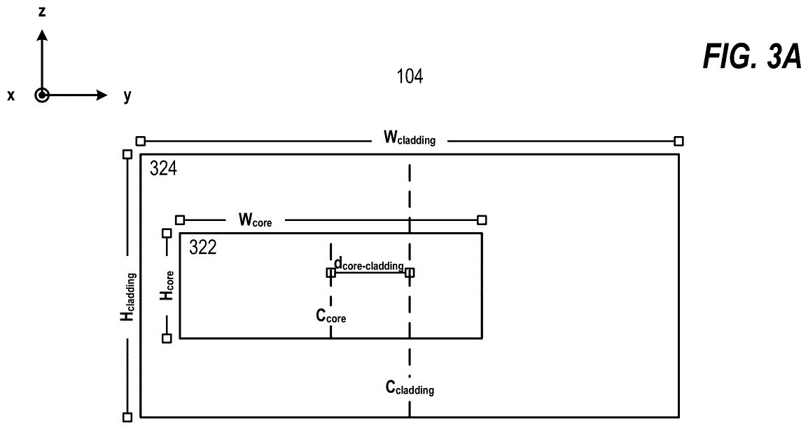

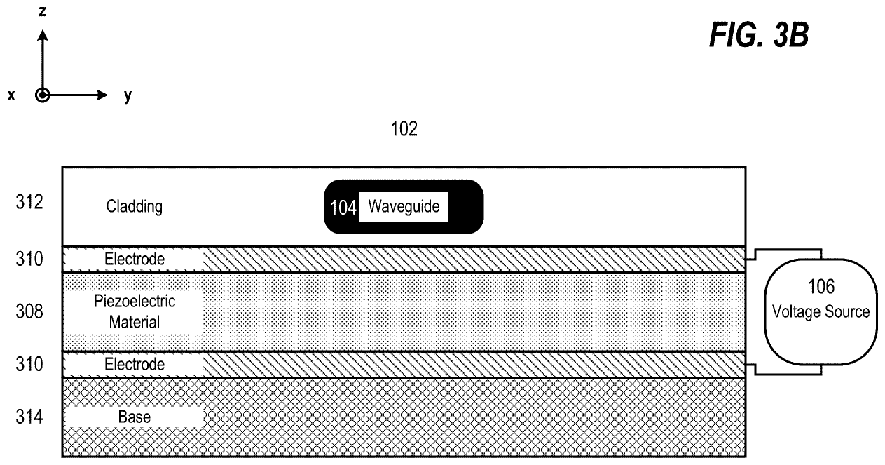

A cross-sectional view of an exemplary embodiment of waveguide 104 is provided in FIG. 3A. As shown, waveguide 104 may comprise a core 322 that is coated in a cladding 324. Core 322 may comprise a waveguide material (e.g., silicon nitride). The center of core 322 (indicated by line C_{core} in FIG. 3A) may be offset from the center of cladding 324 (indicated by line C_{cladding} in FIG. 3A) to increase mode coupling between waveguide 104 and another optoelectronic component toward which waveguide 104 moves following the induction of lateral motion.

In some embodiments, the offset distance between core 322 and cladding 324 is approximately (e.g., within 1%, 5%, 10%, 15%, or 20% of) 50, 75, 100, 125, 150, 175, 200, 225, 250, 275, 300, or 325 nm. In some embodiments, the offset distance between core 322 and cladding 324 is greater than or equal to 25, 50, 75, or 100 nm. In some embodiments, the offset distance between core 322 and cladding 324 is less than or equal to 400, 375, 350, or 300 nm.

The width W_{core} of core 322 may be approximately equal to (e.g., within 1%, 5%, 10%, 15%, or 20% of) 150, 175, 200, 225, 250, 275, 300, 325, 350, 375, 400, or 425 nm. In some embodiments, the width W_{core} of core is greater than or equal to 100, 125, 150, 175, or 200 nm. In some embodiments, the width W_{core} of core is less than or equal to 500, 475, 450, 425, or 400 nm. The width W_{cladding} of cladding 324 may be approximately equal to (e.g., within 1%, 5%, 10%, 15%, or 20% of) 0.5, 0.75, 1, 1.25, 1.5, 1.75, or 2 μm. In some embodiments, width W_{cladding} of cladding 324 is greater than or equal to 0.25, 0.50, 0.75, or 1 μm. In some embodiments, width W_{cladding} of cladding 324 is less than or equal to 2.5, 2.25, 2, 1.75, or 1.5 μm.

The height H_{core} of core 322 may be approximately equal to (e.g., within 1%, 5%, 10%, 15%, or 20% of) 150, 175, 200, 225, 250, 275, 300, 325, 350, 375, or 400 nm. In some embodiments, height H_{core} of core 322 is greater than or equal to 200, 225, 250, 275, or 300 nm. In some embodiments, height H_{core} of core 322 is less than or equal to 400, 375, 350, 325, or 300 nm. The height H_{cladding} of cladding 324 may be approximately equal to (e.g., within 1%, 5%, 10%, 15%, or 20% of) 150, 175, 200, 1, 1.25, 1.5, 1.75, 2, 2.25, 2.5, 2.75, or 3 μm. In some embodiments, height H_{cladding} of cladding 324 is greater than or equal to 0.5, 1, 1.5, or 2 μm. In some embodiments, height H_{cladding} of cladding 324 is less than or equal to 3.5, 3, 2.5, or 2 μm.

A cross-sectional view of a piezoelectric actuator 102 is provided in FIG. 3. As previously noted, each actuator 102 may include a piezoelectric material 308. Piezoelectric material 308 may be any piezoelectric material suitable for use in the system in which the tunable photonic device is intended to be implemented. For example, if the tunable photonic device is intended to be implemented in a quantum computer that operates at cryogenic temperatures, piezoelectric material 308 may be a material that maintains its piezoelectric properties at such temperatures. In some embodiments, piezoelectric material 308 comprises aluminum nitride (AlN), aluminum cadmium nitride, or PZT.

Piezoelectric material 308 may be sandwiched between a pair of electrodes 310. Each electrode 310 may be formed from a conductive material that is compatible with piezoelectric material 308. In some embodiments, each electrode 310 comprises aluminum, an aluminum-copper alloy, or titanium nitride. Voltage source 106 may be electrically coupled to electrodes 310.

An outer surface of each actuator 102 may be coated in a cladding 312. Cladding 312 may cover a portion a portion (e.g., portion 104(a) or portion 104(b) shown in FIG. 1) of waveguide 104 to mechanically couple waveguide 104 to actuator 102. Cladding 312 may comprise silicon dioxide (e.g., low-loss amorphous silica) capable of depositing and evenly filling around waveguide 104. In some embodiments, cladding 312 may have a low Young's modulus to increase its mechanical compliance without compromising its optical properties.

Each actuator 102 may include a base layer 314. Base layer 314 may be a sacrificial layer that is configured to be at least partially removed in order to create a gap between actuator 102 and another surface (e.g., the surface of the PIC that includes the tunable photonic device). The gap that remains when base layer 314 is (partially) removed may provide actuator 102 with sufficient space to deflect out of the unactuated (in FIG. 1, x-y) plane (e.g., enough space to deflect in the −z direction). In some embodiments, base layer 314 comprises silicon (e.g., amorphous silicon). Base layer 314 can also be an underlying silicon dioxide coating layer. In some embodiments, base layer 314 comprises coating portion overlying a sacrificial portion.

As discussed, photonic device 100 may enable the strength of the evanescent coupling between waveguide 104 and another optoelectronic component to be tuned while photonic device is in use. Tuning the strength of the evanescent coupling between waveguide 104 and another optoelectronic component may involve increasing or decreasing the separation distance between waveguide 104 and the other optoelectronic component by applying an appropriate actuation voltage to actuators 102. The other optoelectronic component may be any optoelectronic device capable of evanescently coupling to waveguide 104. Examples of such optoelectronic components to which waveguide 104 may be evanescently coupled include (but are not limited to) other waveguides, phase shifting devices, and ring cavities. In some embodiments, device 100 includes (e.g., is fabricated with) the other optoelectronic component; in other embodiments, device 100 is configured to be installed in a photonic circuit that already includes the other optoelectronic component. In either case, the function of device 100 in the photonic circuit may be defined by the optoelectronic component to which waveguide 104 is coupled.

### Tunable Directional Coupler

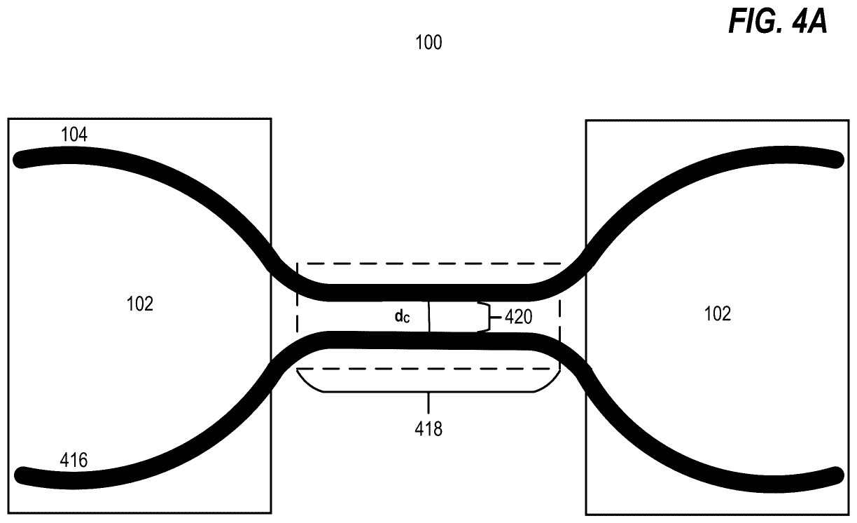

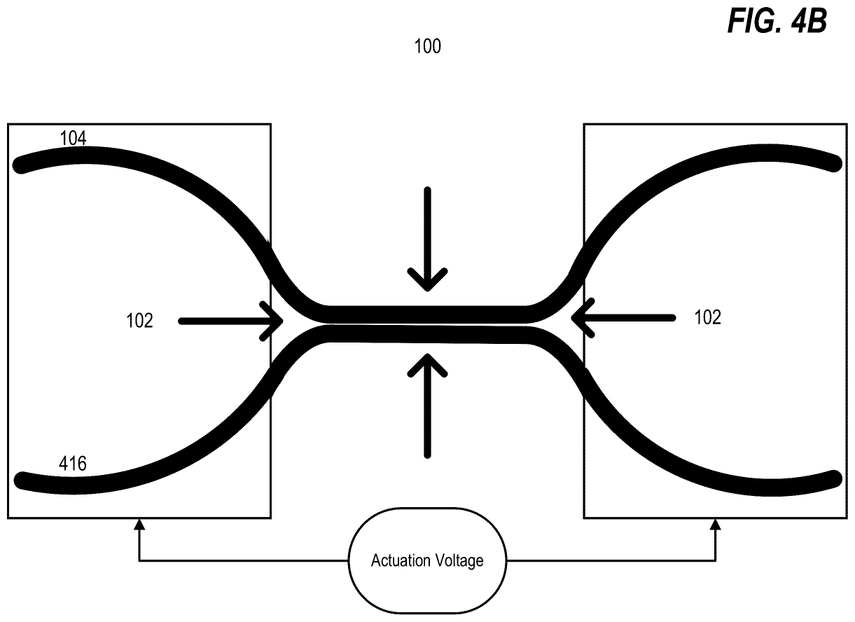

Device 100 can be used to evanescently couple waveguide 104 to a second waveguide. Like waveguide 104, the second waveguide may be suspended between and mechanically coupled to the pair of piezoelectric actuators 102. In particular, as shown in FIGS. 4A-4B, a second waveguide 416 may be suspended symmetrically and convergently with waveguide 104 between actuators 102. In this configuration, device 100 may function as a tunable directional coupler.

The physical and optical properties of waveguide 416 may be identical to those of waveguide 104. When device 100 is in an unactuated state (e.g., when no actuation voltage is applied to actuators 102), the suspended portions of waveguides 104 and 416 may be separated by a coupling gap 418. The size dc of coupling gap 418 may be between 0.01-1 μm, 0.1-0.15 μm, 0.15-0.2 μm, 0.2-0.25 μm, 0.25-0.3 μm, 0.3-0.35 μm, 0.35-0.4 μm, 0.4-0.45 μm, 0.45-0.5 μm, 0.5-0.55 μm, 0.55-0.6 μm, 0.6-0.65 μm, 0.65-0.7 μm, 0.7-0.75 μm, 0.75-0.8 μm, 0.8-0.85 μm, 0.85-0.9 μm, 0.9-0.95 μm, or 0.95-1 μm. In some cases, the size de of coupling gap 418 may exceed 1 μm.

Since waveguide 416, like waveguide 104, may be mechanically coupled to actuators 102, waveguide 416, like waveguide 104, may move laterally whenever longitudinal motion is induced in actuators 102. The lateral movement of waveguide 416 may oppose the lateral motion of waveguide 104 so that, when device 100 is in an actuated state, waveguide 104 and waveguide 416 move toward one another and the size de of coupling gap 418 decreases (as shown in FIG. 4B). When the size of coupling gap 418 is reduced by a sufficient amount, the optical modes of waveguide 104 and waveguide 416 may become well evanescently coupled, and optical signals may be transmitted between waveguide 104 and waveguide 416. The threshold coupling gap size below which waveguide 104 and waveguide 416 become adequately evanescently coupled may be less than or equal to 300 nm, 250 nm, 200 nm, 250 nm, 100 nm, 50 nm, 25 nm, or 10 nm.

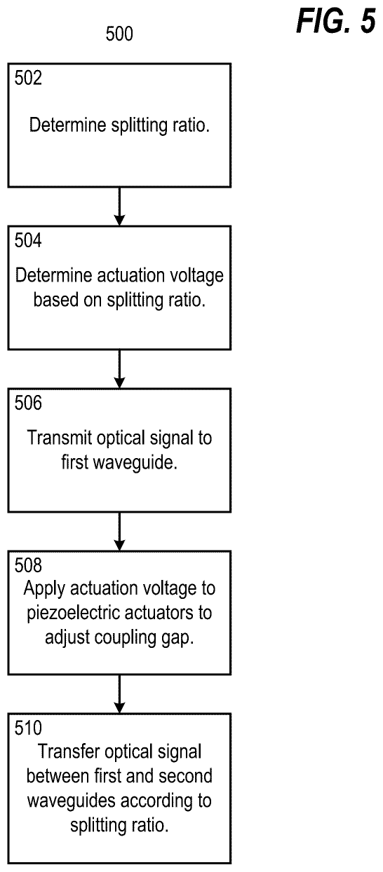

A method 500 of using a piezoelectrically-actuated tunable directional coupler such as the device shown in FIGS. 4A-4B is provided in FIG. 5. Method 500 may be executed whenever an optical signal is received by the directional coupler. One or more steps of method 500 may be executed automatically, for example by one or more processors of a computer system that is connected to the directional coupler.

In a first step 502, a splitting ratio may be determined. The splitting ratio may be a ratio of optical power that will be output from each waveguide in the directional coupler after an optical signal propagates through the directional coupler. The value of the splitting ratio may depend upon the function of the optical signal that is being transmitted through the directional coupler. An actuation voltage to be applied to the piezoelectric actuators may then be determined based on the splitting ratio (step 504). The actuation voltage may control the amount of longitudinal motion induced in the piezoelectric actuators and, as a result, the amount by which the coupling gap between the waveguides in the directional coupler is reduced. In some embodiments, steps 502-504 may be executed prior to the receipt of an optical signal by the directional coupler. For example, the directional coupler may be preprogrammed to apply a particular actuation voltage to the piezoelectric actuators in order to achieve a predetermined splitting ratio. In other embodiments, steps 502-504 may be executed upon receipt of an optical signal by the directional coupler (e.g., according to instructions or input provided by a user or stored in software).

Once the actuation voltage is determined, the optical signal received by the directional coupler may be transmitted into one of the two waveguides in the directional coupler (step 506). The piezoelectric actuators may then be actuated according to the actuation voltage determined in step 504 to reduce the size of the coupling gap between the two waveguides (step 508). When the coupling gap decreases, the strength of the evanescent coupling between the waveguides may increase such that the optical signal is transmitted between the two waveguides according to the splitting ratio (step 510).

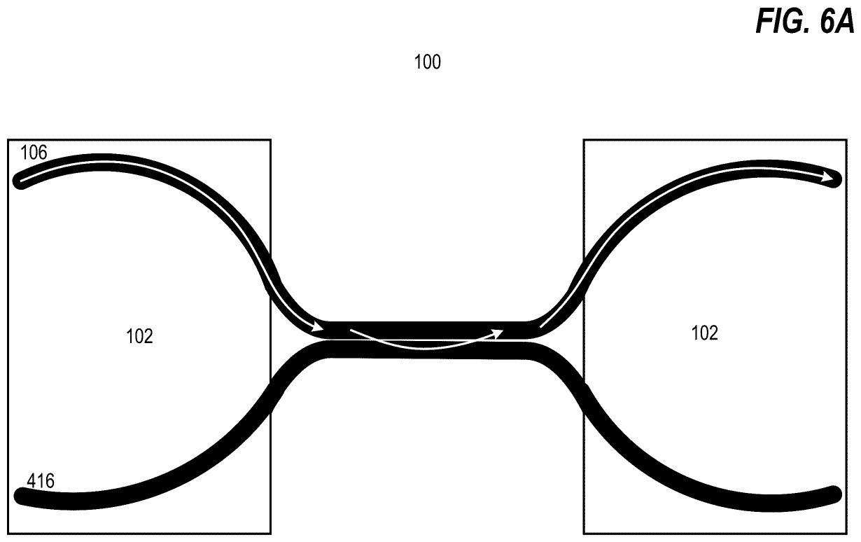

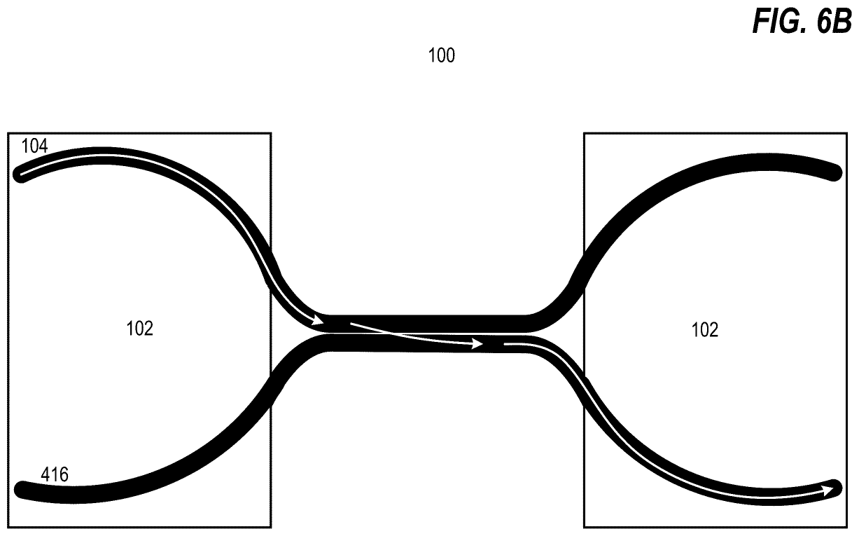

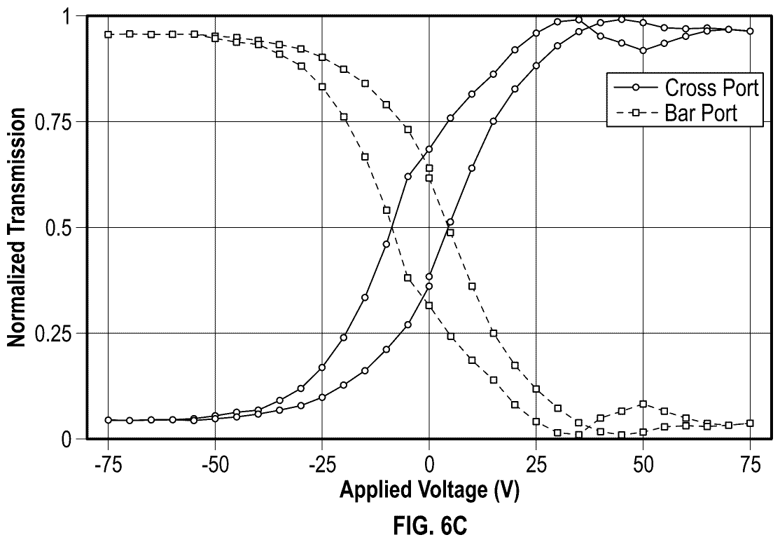

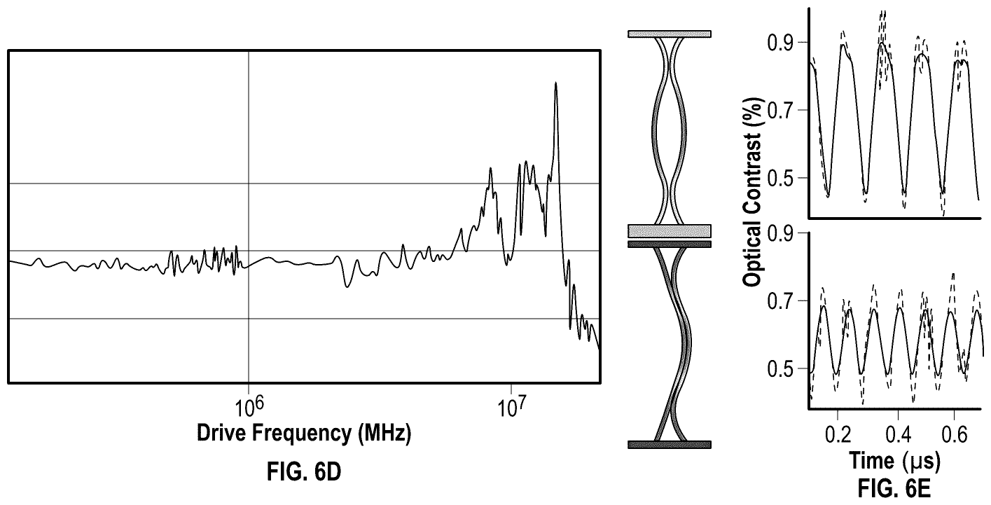

A piezoelectrically-actuated tunable directional coupler such as the device depicted in FIGS. 4A-4B may be tunable between a bar state and a cross state, enabling the directional coupler to function as an optical switch. In the bar state, the directional coupler may transmit power through a single waveguide of the pair of waveguides, as illustrated in FIG. 6A. In the cross state, the directional coupler may completely transfer power from one waveguide to the other waveguide, as illustrated in FIG. 6B.

In a piezoelectrically-actuated tunable directional coupler that is functioning as an optical switch, the piezoelectric actuators may be initially actuated using a first actuation voltage. The first actuation voltage may configure the coupling gap between the two waveguides such that the directional coupler is in a bar state. Adjusting (e.g., increasing or decreasing) the applied actuation voltage from the first actuation voltage to a second actuation voltage may switch the directional coupler from the bar state to a cross state. In some embodiments, the piezoelectrically-actuated tunable directional coupler is configured such that switching between the bar and cross states can occur on-demand. For example, the voltage source that actuates the piezoelectric actuators may be configured to only apply either the first (bar state) actuation voltage or the second (cross state) actuation voltage so that switching between the bar and cross states can be accomplished by switching the voltage source between two preprogrammed voltage values.

Example data showing a relationship between actuation voltage and cross and bar port transmission in a piezoelectrically-actuated tunable directional coupler is provided in FIG. 6C. In this example, the optical transmission from each waveguide in the directional coupler was measured as the actuation voltage applied to the piezoelectric actuators was swept between-75 V and 75 V. As shown in the plot, the cross port displays contrast of 20 dB, while the bar port displays contrast of approximately 14 dB. The relationship between the actuation voltage and the cross and bar port transmission displays closed-loop hysteresis, which may indicate that the initial state of the directional coupler can be recovered after symmetric excursions.

As previously noted, the voltage source in a piezoelectrically-actuated tunable photonic device (e.g., device 100) may apply an AC signal to the piezoelectric actuators. Example data showing the AC response of a piezoelectrically-actuated tunable directional coupler is provided in FIGS. 6D-6E. In this example, the bar port optical contrast was measured as the frequency of a 1 Vₚₚ actuation voltage applied to the piezoelectric actuators was varied between 0 and 500 MHZ. As shown in FIG. 6D, a flat response was observed at frequencies below about 10 MHz. At approximately 11 MHz, a first resonance response was detected. At around 14.8 MHz, optical contrast of nearly 60% was measured. Plots of the time traces of resonant modulation at 11 MHz and 14 MHz are shown in FIG. 6E.

### Phase Shifter

In addition to being configured to function as a tunable directional coupler, as discussed in the preceding section, device 100 may be configured to function as a phase shifting device. In this case, device 100 may include a second waveguide that is configured to induce phase changes in optical signals as said optical signals propagate through the second waveguide. Evanescently coupling the first waveguide 104 to the second, phase-shifting waveguide may allow the phase of an optical signal received by device 100 to be adjusted.

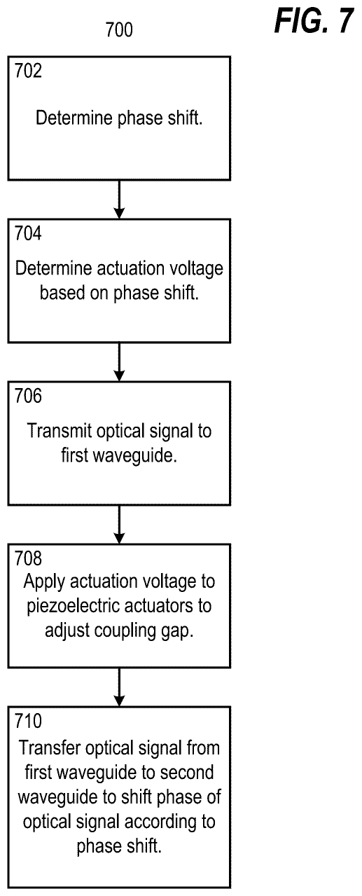

An example method 700 of using a piezoelectrically-actuated tunable photonic device to adjust the phase of an optical signal received by the device is provided in FIG. 7. Like method 500 shown in FIG. 5, method 700 may be executed whenever an optical signal is received by the photonic device. One or more steps of method 700 may be executed automatically, for example by one or more processors of a computer system that is connected to the photonic device.

In a first step 702, a phase shift to be applied to the received optical signal may be determined. In some embodiments, the phase shift is determined based on input from a user or based on an intended function of the optical signal. The phase shift may be used to determine an actuation voltage to be applied to the piezoelectric actuators (step 704). After the actuation voltage is determined, the optical signal received by the photonic device may be transmitted to the first (non-phase-shifting) waveguide (step 706). The actuation voltage may then be applied to the piezoelectric actuators in order to reduce the separation distance between the first waveguide and the second, phase-shifting waveguide (step 708). The reduction in the separation distance (i.e., the reduction of the coupling gap) may increase the strength of the evanescent coupling between the two waveguides, allowing the optical signal to transfer between the first and second waveguide. A phase change may be imparted upon the optical signal as it propagates through the second, phase-shifting waveguide (step 710).

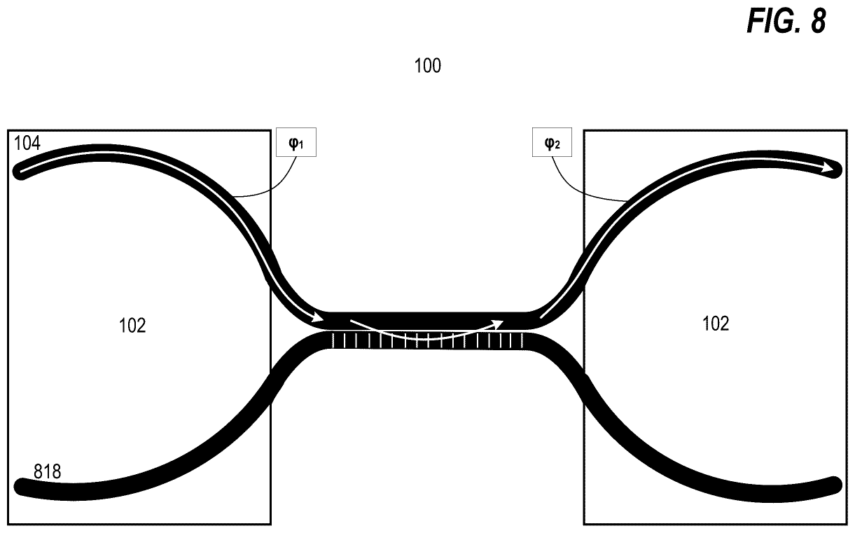

FIG. 8 depicts an embodiment of piezoelectrically-actuated tunable photonic device 100 that is configured to function as a phase-shifting device. In this embodiment, device 100 includes a phase-shifting device 818 that is suspended between and mechanically coupled to piezoelectric actuators 102. The geometry of this embodiment of device 100 in an unactuated state may be similar to the geometry of the embodiment of device 100 that is shown in FIG. 4A (e.g., in an unactuated state, waveguide 104 and phase-shifting device 818 may be separated by a coupling gap that is similar in size to coupling gap 418 shown in FIG. 4A). Since phase-shifting device 818, like waveguide 104, may be mechanically coupled to actuators 102, waveguide 818, like waveguide 104, may move laterally whenever longitudinal motion is induced in actuators 102. The lateral movement of phase-shifting device 818 may oppose the lateral motion of waveguide 104 so that, when device 100 is in an actuated state, waveguide 104 and phase-shifting device 818 move toward one another, reducing their separation distance. When the separation distance is reduced by a sufficient amount, the optical modes of waveguide 104 and phase-shifting device 818 may become well evanescently coupled.

Phase-shifting device 818 may be a non-guided structure configured to impart phase changes upon optical signals. When waveguide 104 and phase-shifting device 818 become evanescently coupled, phase-shifting device 818 may be capable of imparting a phase shift on an optical signal being guided by waveguide 104 that causes the phase of the optical signal to change from a first phase φ₁ to a second phase φ₂. The difference between the first phase and the second phase may depend on the size of the coupling gap between waveguide 104 and phase-shifting device 818.

### Ring Cavity

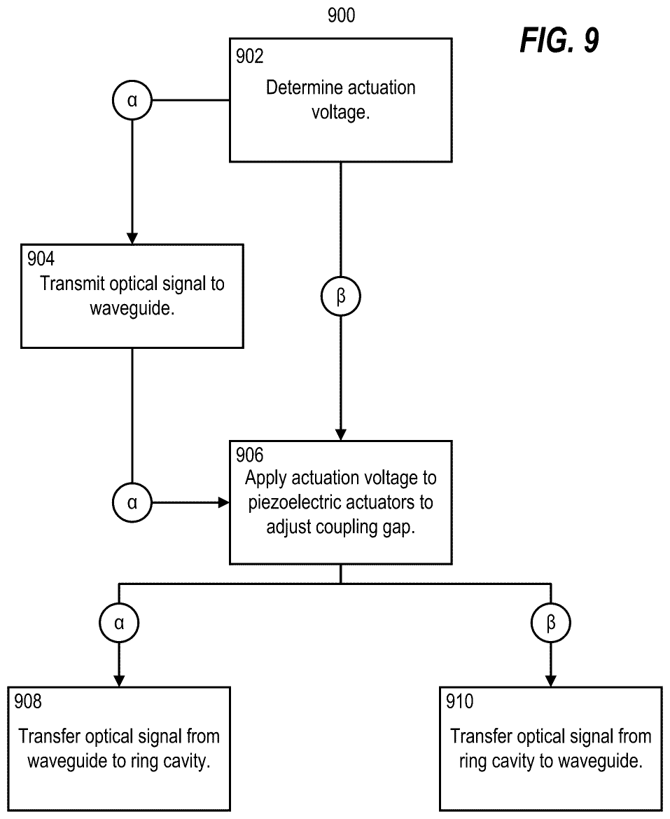

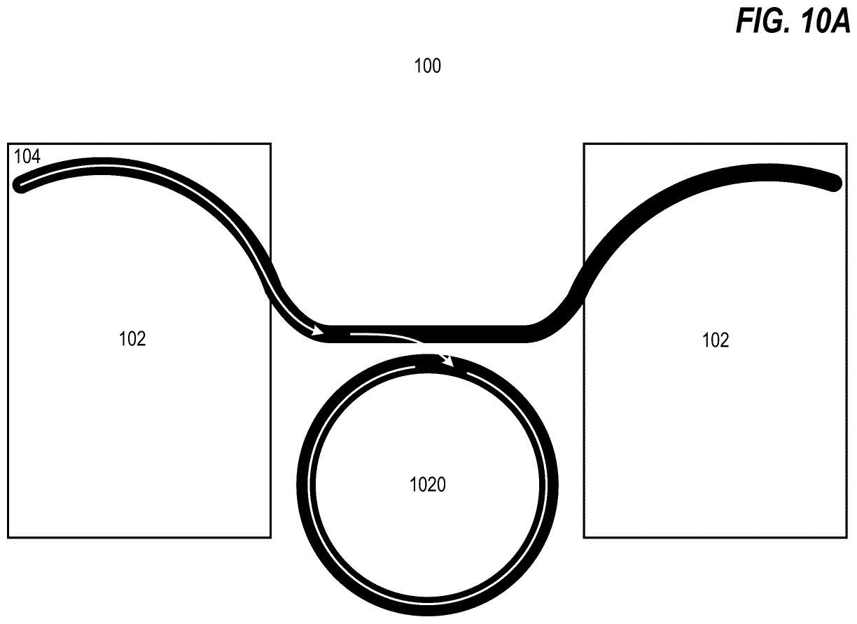

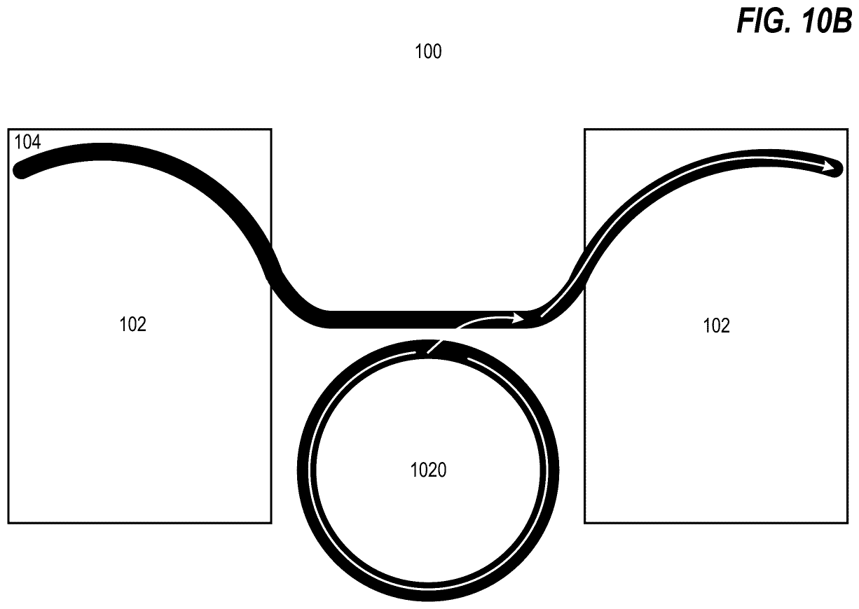

Device 100 can also be configured to transfer optical signals to, and retrieve optical signals from, a ring cavity by tuning the separation distance between waveguide 104 and the ring cavity. Applications of such configurations of device 100 include photon storage, photon delay, and emitter photon extraction. An example method 900 of using a piezoelectrically-actuated tunable photonic device to transfer optical signals between a waveguide and a ring cavity is provided in FIG. 9; illustrations of the transfer of optical signals between waveguide 104 and a ring cavity 1020 are shown in FIGS. 10A-10B.

In a first step 902 of method 900, an actuation voltage may be determined. If the photonic device is being used to transfer an optical signal received by the device to the ring cavity (the “x” branch of method 900), the optical signal may be transmitted to the waveguide (step 904), at which point the actuation voltage may be applied to the piezoelectric actuators (step 906) to reduce the separation distance between the waveguide and the ring cavity. Once the separation distance has reduced, the optical signal may be transmitted from the waveguide to the ring cavity (step 908), as shown in FIG. 10A. If, on the other hand, the photonic device is being used to extract an optical signal from the ring cavity (the “B” branch of method 900), the actuation voltage may be applied to the piezoelectric actuators (step 906) to reduce the separation distance between the waveguide and the ring cavity and, once the separation distance has reduced, the optical signal may be transmitted to the waveguide from the ring cavity (step 910), as shown in FIG. 10B.

### SU2 Transformation

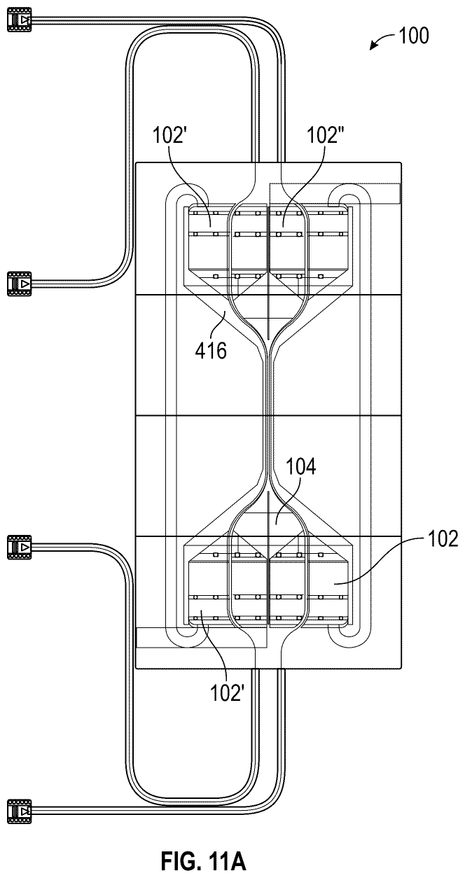

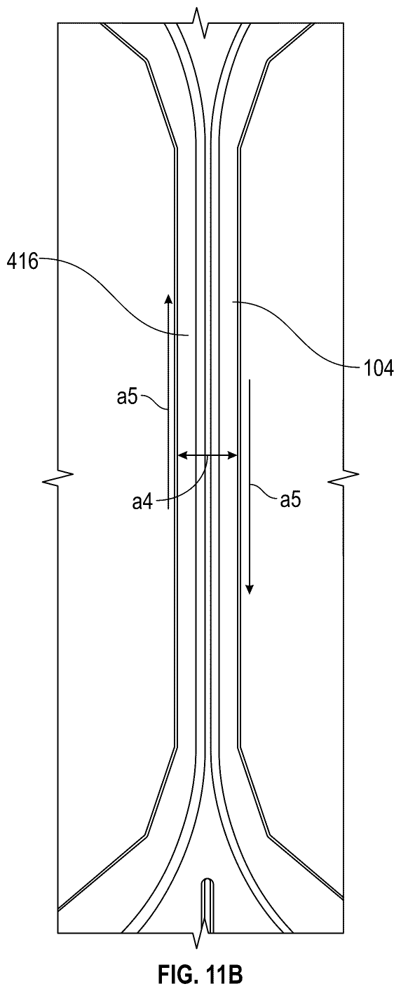

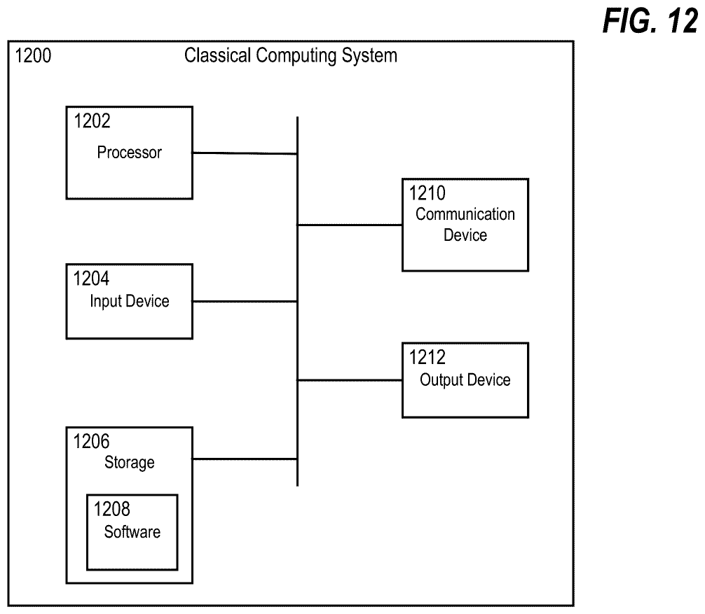

A piezoelectrically-actuated tunable photonic device may be adapted to form a device that can adjust both the amplitude and the phase of optical signals. That is, a piezoelectrically-actuated tunable photonic device may be used to implement a full SU2 transformation. Like the directional coupler shown in FIG. 4, the amplitude and phase adjusting device may, in addition to waveguide 104, include a second waveguide 416, as shown in FIGS. 11A-11B. Longitudinal motion, along with lateral motion, may be induced in waveguide 104 and waveguide 416 by splitting each actuator of the pair of actuators in two to create a first actuator 102′ and a second actuator 102″. Each of the four actuators may be independently controlled by a voltage source. Applying symmetric actuation voltages to the actuators may induce lateral motion (indicated by arrow a₄ in FIG. 11B) in waveguides 104 and 416, while applying differential actuation voltages to the actuators may induce longitudinal motion (indicated by arrows as in FIG. 11B) in waveguides 104 and 416.

As noted, various functions of the piezoelectrically-actuated tunable photonic devices described herein may be controlled using a computer system. For instance, the voltage source that applies the actuation voltage to the piezoelectric actuators in a piezoelectrically-actuated tunable photonic device may be controlled by a computer system that is connected to the photonic device. A computer system may also control the input of optical signals into a piezoelectrically-actuated tunable photonic device (e.g., by directing optical signal received by the device into a specific waveguide) or the output of optical signals from a piezoelectrically-actuated tunable photonic device (e.g., by directing optical signals from the device to other components of a photonic circuit in which the device is integrated).

An exemplary computer system 1200 is provided in FIG. 11. Computer system 1200 can be any suitable type of microprocessor-based device, such as a personal computer, workstation, server, or handheld computing device (portable electronic device) such as a phone or tablet, or dedicated device. As shown in FIG. 1B, computer system 1200 may include one or more processors 1202, an input device 1204, an output device 1212, storage 1206, and a communication device 1210.

Input device 1204 and output device 1212 can be connectable or integrated with system 1200. Input device 1204 may be any suitable device that provides input, such as a touch screen, keyboard or keypad, mouse, or voice-recognition device. Likewise, output device 1212 can be any suitable device that provides output, such as a display, touch screen, haptics device, or speaker.

Storage 1206 can be any suitable device that provides (classical) storage, such as an electrical, magnetic, or optical memory, including a RAM, cache, hard drive, removable storage disk, or other non-transitory computer readable medium. Communication device 1210 can include any suitable device capable of transmitting and receiving signals over a network, such as a network interface chip or device. The components of computer system 1200 can be connected in any suitable manner, such as via a physical bus or via a wireless network.

Processor(s) 1202 may be or comprise any suitable classical processor or combination of classical processors, including any of, or any combination of, a central processing unit (CPU), a field programmable gate array (FPGA), and an application-specific integrated circuit (ASIC). Software 1208, which can be stored in storage 1206 and executed by processor(s) 1202, can include, for example, the programming that embodies the functionality of the present disclosure. Software 1208 may be stored and/or transported within any non-transitory computer-readable storage medium for use by or in connection with an instruction execution system, apparatus, or device that can fetch instructions associated with the software from the instruction execution system, apparatus, or device and execute the instructions. In the context of this disclosure, a computer-readable storage medium can be any medium, such as storage 1206, that can contain or store programming for use by or in connection with an instruction execution system, apparatus, or device.

Software 1208 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Computer system 1200 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer system 1200 can implement any operating system suitable for operating on the network. Software 1208 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A photonic device comprising:
a pair of piezoelectric actuators;
a waveguide suspended between and mechanically coupled to the pair of piezoelectric actuators;
a voltage source configured to apply an actuation voltage to the pair of piezoelectric actuators to induce longitudinal motion in each actuator of the pair of piezoelectric actuators, wherein the longitudinal motion of the pair of piezoelectric actuators induces lateral motion in the waveguide.

2. The photonic device of claim 1, comprising an optoelectronic element that is spatially separated from the waveguide by a coupling gap, wherein the lateral motion induced in the waveguide reduces the size of the coupling gap for evanescently coupling the waveguide to the optoelectronic element during operation.

3. The photonic device of claim 2, wherein the optoelectronic element is a second waveguide.

4. The photonic device of claim 3, wherein:
the second waveguide is suspended between and mechanically coupled to the pair of piezoelectric actuators, and
the longitudinal motion induced in the pair of piezoelectric actuators by the application of the actuation voltage induces lateral motion in the second waveguide that reduces the size of the coupling gap.

5. The photonic device of claim 2, wherein optoelectronic element is a phase-shifting device configured change a phase of an evanescently-coupled optical signal.

6. The photonic device of claim 2, wherein the optoelectronic element is a ring cavity.

7. The photonic device of claim 1, wherein the waveguide is a silicon nitride (SiN) waveguide.

8. The photonic device of claim 1, wherein each actuator of the pair of piezoelectric actuators comprises a layer of piezoelectric material disposed between a pair of electrodes.

9. The photonic device of claim 8, wherein the piezoelectric material comprises aluminum nitride (AlN).

10. The photonic device of claim 8, wherein the voltage source is electrically coupled to the pair of electrodes of each actuator of the pair of piezoelectric actuators.

11. The photonic device of claim 1, wherein each actuator of the pair of piezoelectric actuators comprising a cladding that mechanically couples the waveguide to the actuator.

12. The photonic device of claim 11, wherein the cladding is a silicon dioxide cladding.

13. The photonic device of claim 1, wherein the lateral motion induced in the waveguide is amplified relative to the longitudinal motion of the pair of piezoelectric actuators.

14. The photonic device of claim 13, wherein a total amount of lateral motion induced in the waveguide is at least twenty times a total amount of longitudinal motion induced in the pair of piezoelectric actuators.

15. A method for controlling motion of a waveguide in a photonic device, the method comprising:
determining an actuation voltage; and
applying the actuation voltage to a pair of piezoelectric actuators using a voltage source to induce longitudinal motion in each actuator of the pair of piezoelectric actuators, wherein the longitudinal motion of the pair of piezoelectric actuators induces lateral motion in a waveguide that is suspended between and mechanically coupled to the pair of piezoelectric actuators.

16. The method of claim 15, wherein the lateral motion induced in the waveguide reduces the size of a coupling gap between the waveguide and an optoelectronic element and evanescently couples the waveguide to the optoelectronic element.

17. The method of claim 16, comprising:
transmitting an optical signal to the waveguide;
while applying the actuation voltage, transferring the optical signal between the waveguide and the optoelectronic element.

18. The method of claim 16, wherein the optoelectronic element is a second waveguide.

19. The method of claim 18, wherein:
the second waveguide is suspended between and mechanically coupled to the pair of piezoelectric actuators,
the longitudinal motion induced in the pair of piezoelectric actuators by the application of the actuation voltage induces lateral motion in the second waveguide that reduces the size of the coupling gap.

20. The method of claim 19, comprising determining a splitting ratio of the waveguides, wherein the actuation voltage is determined based on the splitting ratio.

21. The method of claim 16, wherein the optoelectronic element is a phase-shifting device configured change a phase of an evanescently-coupled optical signal,
wherein the method comprises determining a phase shift,
wherein the actuation voltage is determined based on the phase shift.

22. The method of claim 16, wherein the optoelectronic element is a ring cavity.

23. The method of claim 22, comprising:
storing an optical signal in the ring cavity; and
while applying the actuation voltage, transferring the optical signal from the ring cavity to the waveguide.
